(19) United States
(12) Patent Application Publication
(10) Pub. No.: US 2011/0176227 A1
(43) Pub. Date: Jul. 21, 2011

(54) SINGLE FOCUS WIDE-ANGLE LENS MODULE

(76) Inventor: FEI-HSIN TSAI, Wai Pu Hsiang (TW)

(21) Appl. No.: 12/690,122

(22) Filed: Jan. 20, 2010

(51) Int. Cl. G02B 13/18

(52) U.S. Cl. 359/717

(57) ABSTRACT

A single focus wide-angle lens module includes a fixed aperture diaphragm, a first lens and a second lens arranged from an object side to an image side in a sequence of: the diaphragm, the first lens and the second lens. The first lens has a positive refractive power, a concave surface on the object side and at least one aspheric surface. The second lens has a negative refractive power, a convex surface on the object side and at least one aspheric surface.

### BACKGROUND OF THE INVENTION

1. Field of the Invention

The present invention relates to the field of optical lenses, and more particularly to a small-sized two-piece single focus lens module capable of capturing infrared rays.

2. Description of the Prior Art

As digital imaging technologies advances, present digital carriers such as digital cameras and mobile phones tend to be miniaturized. Thus the sensors such as CCD or CMOS are also miniaturized.

Infrared condensing lens modules are used not only in the photograph field, but also in the infrared capturing and detecting field in recent years. Thus they are requested to provide miniaturized structure with wider detecting angle.

### SUMMARY OF THE INVENTION

The main object of the present invention is to provide a single focus wide-angle lens module with better focusing and heat condensing performances.

Another object of the present invention is to provide a two-piece single focus wide-angle lens module with bigger detecting angle and optical properties.

To achieve the above and other objects, a single focus wide-angle lens module of the present invention includes a fixed aperture diaphragm, a first lens and a second lens, arranged from an object side to an image side in a sequence of: the diaphragm, the first lens and the second lens.

The first lens has a positive refractive power, concave surface on the object side and at least one aspheric surface. The second lens has a negative refractive power, a convex surface on the object side and at least one aspheric surface.

Thereby, the detecting angle of the lens module is expected to increase, and the lens amount, the weight, the volume and the thickness of the lens module are all reduced, thus meets the product installation requirements.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic view showing an imaging lens module in accordance with a first preferred embodiment of the present invention;

FIG. 1A is a schematic view showing the aberration of an imaging lens module in accordance with a first preferred embodiment of the present invention;

FIG. 1B is a schematic view showing the data of optical features and aspheric surface coefficients of an imaging lens module in accordance with a first preferred embodiment of the present invention;

FIG. 2 is a schematic view showing an imaging lens module in accordance with a second preferred embodiment of the present invention;

FIG. 2A is a schematic view showing the aberration of an imaging lens module in accordance with a second preferred embodiment of the present invention;

FIG. 2B is a schematic view showing the data of optical features and aspheric surface coefficients of an imaging lens module in accordance with a second preferred embodiment of the present invention.

### DETAILED DESCRIPTION OF THE PREFERRED EMBODIMENTS

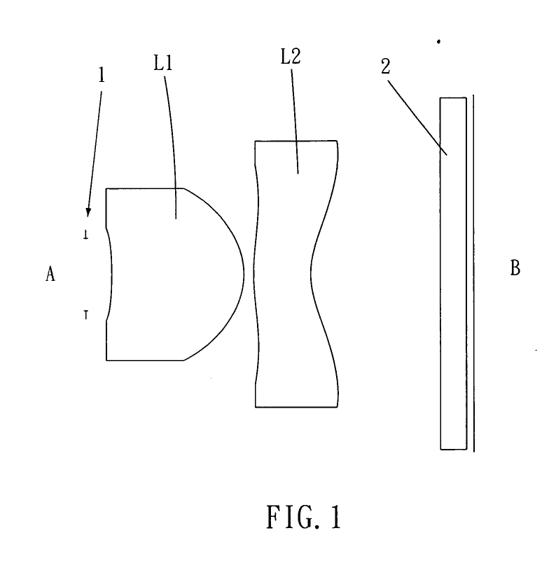

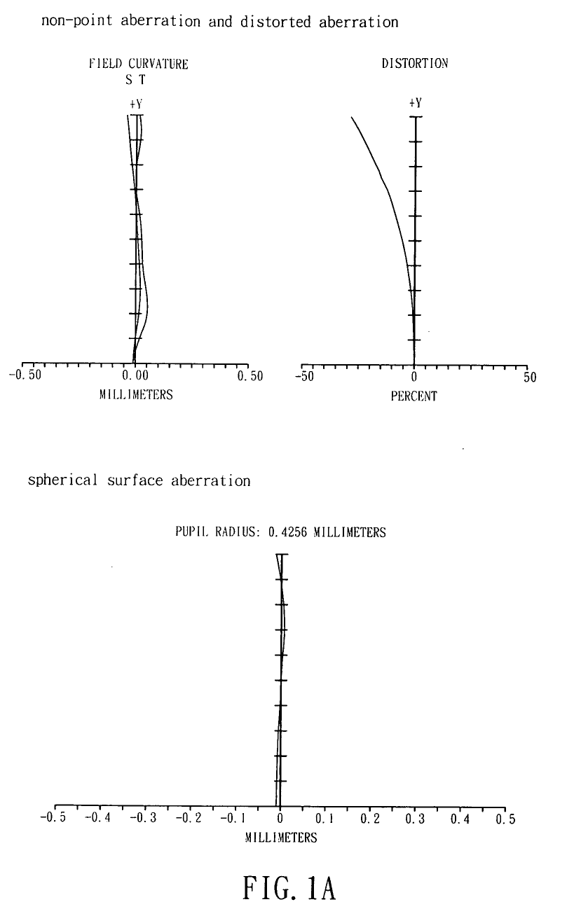

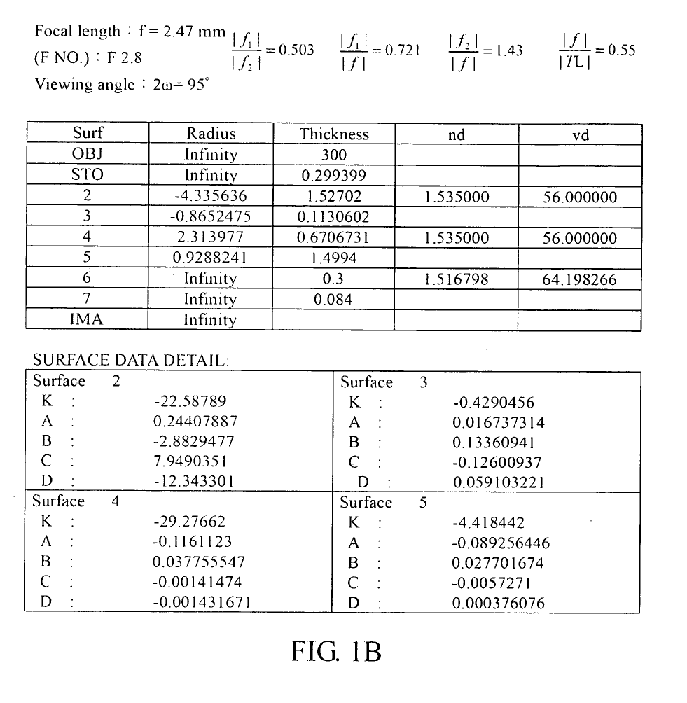

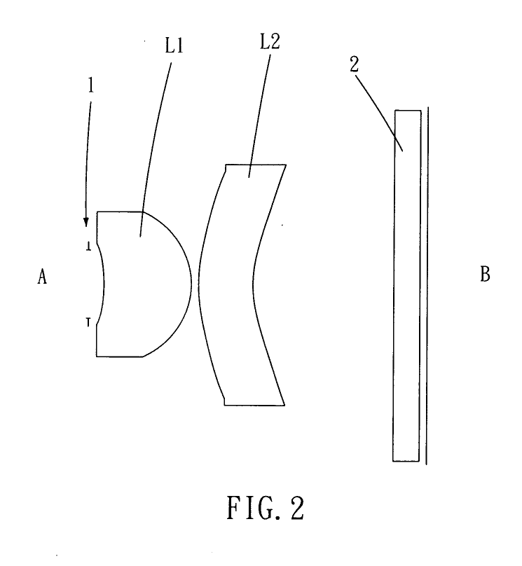

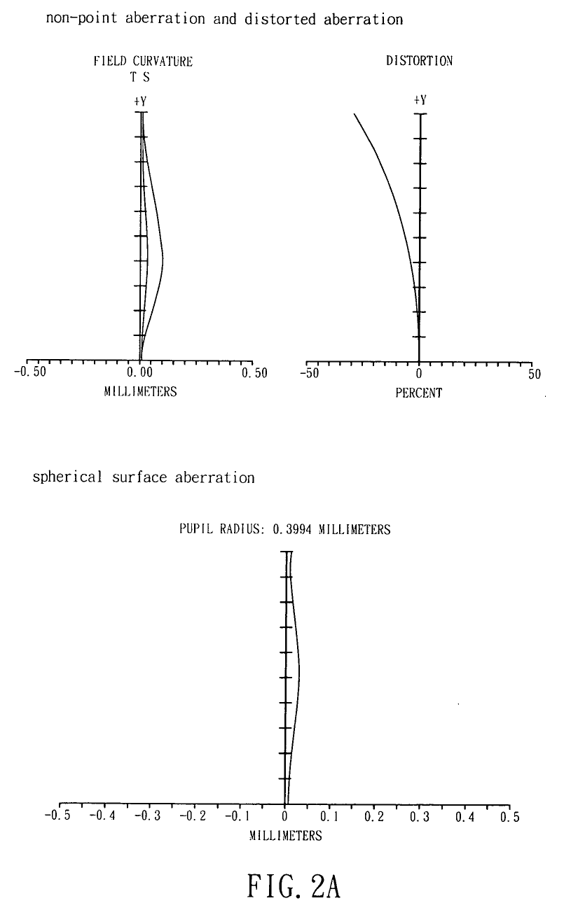

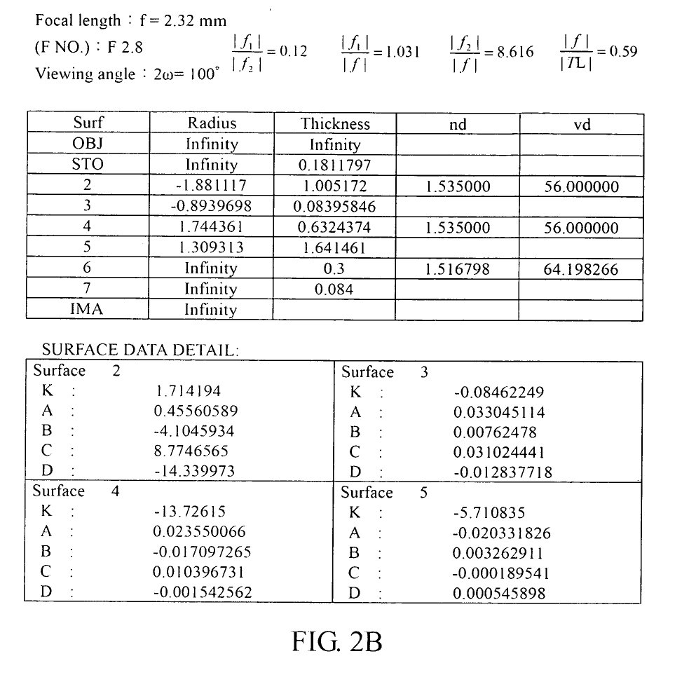

FIG. 1 and FIG. 2 show schematic views of lens modules in accordance with the first and second preferred embodiments of the present invention respectively. Each lens module includes a fixed aperture diaphragm 1 and an optical module, which includes a first lens L1 and a second lens L2. The diaphragm 1 and the optical module are arranged from an object side A to an image side B is a sequence of: the diaphragm 1, the first lens L1 and the second lens L2.

The first lens L1 has positive refractive power, a concave surface on the object side A and at least one aspheric surface. The second lens L2 has a negative refractive power, a convex surface on the object side A and at least one aspheric surface.

In the optical module composed of two lenses in accordance to the system of the invention, a plane glass 2 is disposed behind the second lens L2 for infrared rays to transmit therethrough. In addition, the image side B refers to an infrared sensor.

Each lens is made by a plastic material or a glass material. The plastic material allows the lens to be shown in the structure with an aspheric surface, and the lens is used as an aspheric lens for providing a higher resolving power and reducing the number of lenses required for the imaging process, so as to achieve a good detecting quality of the lens module.

In addition, the schematic views of the aberration of the invention are non-point aberration, distorted aberration and spherical surface aberration as shown in FIG. 1A and FIG. 2A. Regardless of which aberration, the aberration relates to a data of a line d, and the non-point aberration relates to the data of an S image plane (SAGITTAL) which is related to the data of a T image plane (TANGENTIAL).

From the figures of the aberrations, the correction of the aberration of the invention is obtained completely from a simulated design, and thus there will be no problems in practical applications.

Refer to FIG. 1B and FIG. 2B for the data of aspheric surfaces in accordance with the first and second preferred embodiments of the invention, the data displayed at the top are numerals representing each lens or element of the optical module of the invention.

The value of F. No. shows the parameter of brightness. The smaller the value of F is, the higher the brightness is.

Viewing angle: 2ω.

Focal Length f: f is the overall focal length (mm) of the optical module, and 2, 3, 4, 5, 6, 7 listed below are numbers of lenses counting in a sequence starting from the object side; the surface numbers 2, 3 represent two surfaces of the first lens L1, the surface numbers 4, 5 represent two surfaces of the second lens L2, the surface numbers 6, 7 represent two surfaces of the plane glass 2.

In the present invention, the focal length value f1 of the third lens and the focal length value f2 of the second lens must satisfy the following relationship:

0<|f1|/|f2|<1

In the present invention, the focal length value f1 of the first lens and the focal length value f of the whole lens module must satisfy the following relationship:

0.2<|f1|/|f|<1.8

In the present invention, the focal length value f2 of the second lens and the focal length value f of the whole lens module must satisfy the following relationship:

0<|f2|/|f|<12

Also, the focal length value f of the whole lens module and the distance TL between the first surface of the first lens and an imaging surface must satisfy the following relationship:

0.2<|f/TL|<1

If the above relationship is not satisfied, the performance, the resolving power and the yield rate of the lens module will be decrease.

Since every lens of the lens module has at least one aspheric surface, the shape of the aspheric surface must satisfy the condition of the following formula:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Gh}^{14} + …$$

Where, z is a value of a reference position with respect to a vertex of the surface along the optical axis and at a position with a height h; k is a conic constant; c is the reciprocal of a radius of curvature; and A, B, C, D, E, G, . . . are coefficients of high level aspheric surfaces.

In the single focus wide-angle lens module of the present invention, the coordination of the first and second lenses enable the lens module to obtain wider viewing angle, i.e. the detecting angle which has reached at least 95 degrees and maintain the resolving power of the lens module as well.

In addition, the amount of the lenses in the present invention is miniaturized, so as to meet the product installation requirements.

What is claimed is:

1. A single focus wide-angle lens module, comprising a fixed aperture diaphragm, a first lens and a second lens, arranged from an object side to an image side in a sequence of:
the fixed aperture diaphragm;
the first lens, having a positive refractive power, concave surface on the object side and at least one aspheric surface;
the second lens, having a negative refractive power, a convex surface on the object side and at least one aspheric surface.

2. The lens module of claim 1, wherein 0<|f1|/|f2|<1, and f1 is a focal length value of the first lens, f2 is a focal length value of the second lens.

3. The lens module of claim 1, wherein 0.2<|f1|/|f|<1.8, and f1 is a focal length value of the first lens, f is a focal length value of the whole lens module.

4. The lens module of claim 2, wherein 0.2<|f1|/|f|<1.8, and f1 is a focal length value of the first lens, f is a focal length value of the whole lens module.

5. The lens module of claim 1, wherein 0<|f2|/|f|<12, and f2 is a focal length value of the second lens, f is a focal length value of the whole lens module.

6. The lens module of claim 4, wherein 0<|f2|/|f|<12, and f2 is a focal length value of the second lens, f is a focal length value of the whole lens module.

7. The lens module of claim 1, wherein 0.2<|f/TL|<1, and f is a focal length value of the whole lens module, TL is the distance between a first surface of the first lens and an imaging surface.

8. The lens module of claim 6, wherein 0.2<|f/TL|<1, and f is a focal length value of the whole lens module, TL is the distance between a first surface of the first lens and an imaging surface.

9. The lens module of claim 1, wherein the aspheric surface is in a shape satisfying a formula of:
$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Gh}^{14} + …$$
and z is a value of a reference position with respect to a vertex of the surface along the optical axis and at a position with a height h; k is a conic constant; c is the reciprocal of a radius of curvature; and A, B, C, D, E, G . . . are coefficients of high level aspheric surfaces.

10. The lens module of claim 8, wherein the aspheric surface is in a shape satisfying a formula of:
$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Gh}^{14} + …$$
and z is a value of a reference position with respect to a vertex of the surface along the optical axis and at a position with a height h; k is a conic constant; c is the reciprocal of a radius of curvature; and A, B, C, D, E, G . . . are coefficients of high level aspheric surfaces.
